(19) United States
(12) Patent Application Publication
(10) Pub. No.: US 2003/0047342 A1
(43) Pub. Date: Mar. 13, 2003

(54) Cable connection for network using Ethernet protocol

(76) Inventors: Phillip R. Rotta, Kirkland, WA (US); John G. MacDuff JR., Issaquah, WA (US)

Correspondence Address: HARNESS, DICKEY & PIERCE, P.L.C., P.O. BOX 828, BLOOMFIELD HILLS, MI, 48303, US

(21) Appl. No.: 09/949,435

(22) Filed: Sep. 7, 2001

(51) Int. Cl. H01B 1/00; H02G 1/00

(52) U.S. Cl. 174/68.1

(57) ABSTRACT

A computer network that utilizes an Ethernet protocol. The computer network includes a first network device, a second network device, a first cable assembly coupling the first and second network devices to one another and facilitating data transmission from the first network device to the second network device, and a second cable assembly coupling the first and second network devices to one another and facilitating data transmission from the second network device to the first network device. Each of the first and second cable assemblies consists essentially of a cable, a first contact assembly and a second contact assembly. The cable is formed with a pair of wires that are twisted about one another and shielded by at least one shield conductor. Each of the first and second contact assemblies include a first conductor, which is electrically coupled to a first one of the wires, a second conductor, which is electrically coupled to the other one of the wires, and a third conductor, which is electrically coupled to the shield conductor.

### FIELD OF THE INVENTION

The present invention generally relates to computer networks and more particularly to a cable connection for a computer network that utilizes a high speed Ethernet protocol.

### BACKGROUND OF THE INVENTION

Over the past several years, advances in computer networking technology have facilitated a corresponding increase in the rate at which data may be transmitted through a network. In a typical office network (i.e., land-based and stationary), it is relatively common place to connect devices, such as computer work stations, hubs and switches, to one another with a twisted-shielded-quad cable assembly. The twisted-shielded-quad cable assembly typically includes a cable and a pair of commercially available RJ-45 modular (telephone type) connectors. The cable is formed by twisting four individual insulated wires and thereafter surrounding these wires with a shield and an outer protective/insulating jacket. Despite the wide spread use of such cable assemblies, several drawbacks are known.

One drawback relates to the RJ-45 connector and its relative robustness. When these cable assemblies are integrated into mobile platforms, such as aircraft, for example, their drawbacks become more apparent due to their exposure to temperature extremes, dust, moisture and relatively large levels of vibration. The harshness of the environment that is provided by a mobile platform typically reduces the reliability of these cable assemblies by a substantial amount and as such, they are not well suited for use in certain situations in mobile platforms. Another drawback of this type of cable is that each data cable must be discretely connected and disconnected and as such, the servicing of large systems would necessitate a relatively large amount of time for simply connecting and disconnecting the data cables.

One proposed solution is known as the ARINC 763 standard, under which one or more data cables are integrated into a cable assembly. Each of the data cables typically includes a set of twisted pair conductors, and a shield conductor. The end of the data cable is coupled to a connector assembly that typically houses 150 or more conductors. The ARINC 763 standard provides that the twisted pair of conductors for each data cable be discretely coupled to individual pin contacts, while the corresponding shield conductor be coupled either to a contact or to a ground block. The pin conductors that are not coupled to data cables may be used to transmit electric power and/or other electric signals. The pin contacts and the construction of the connector assembly produce a system, which is highly robust in terms of its resistance to vibration, moisture, dust and temperature, as well as provide a system whereby many electrical connections may be simultaneously made in a relatively short amount of time. The parasitic electromagnetic emission produced by transmission of high-speed data on such a system is generally in excess of that which is acceptable to prevent interference with sensitive navigation equipment elsewhere on the mobile platform. This is particularly true when the cable bundle containing the high-speed data cables also contains a mix of other electrical discrete signals and power.

Accordingly, there remains a need in the art for an improved cable assembly for transmitting data in an Ethernet computer network wherein the level of parasitic radiated emissions produced by data transmission through the Ethernet cable assembly, is minimal, and the cable assembly is; highly robust, capable of being connected and disconnected on a repeated basis, and provides a reliable connection for high speed Ethernet protocols.

### SUMMARY OF THE INVENTION

In one preferred form, the present invention provides a computer network that utilizes an Ethernet protocol. The computer network includes a first network device, a second network device, a first cable assembly coupling the first and second network devices to one another and facilitating data transmission from the first network device to the second network device, and a second cable assembly coupling the first and second network devices to one another and facilitating data transmission from the second network device to the first network device. Each of the first and second cable assemblies consists essentially of a cable, a first contact assembly and a second contact assembly. The cable is formed with a twisted-shielded wire pair and includes at least one shield conductor. Each of the first and second connectors includes a first conductor, which is electrically coupled to a first one of the pair of twisted-shielded wires, a second conductor, which is electrically coupled to the other one of the pair of twisted-shielded wires, and a third conductor, which is electrically coupled to the shield conductor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a schematic illustration of the computer network constructed in accordance with the teachings of the present invention and installed on a mobile platform;

FIG. 2 is a partially broken-out perspective view of a portion of the computer network, illustrating the construction of the cable assembly in greater detail;

FIG. 2a is a partially broken-out perspective view of a portion of the cable assembly illustrating the construction of the conductor assembly in greater detail;

FIG. 3 is a front perspective view of the cable assembly illustrating the connector in greater detail;

FIG. 4 is a schematic illustration of a portion of the computer network of FIG. 1, illustrating the electrical connection for transmitting data between two devices; and

FIG. 5 is a schematic illustration of a cable assembly constructed in accordance with the teachings of the present invention.

### DETAILED DESCRIPTION OF THE PREFERRED EMBODIMENTS

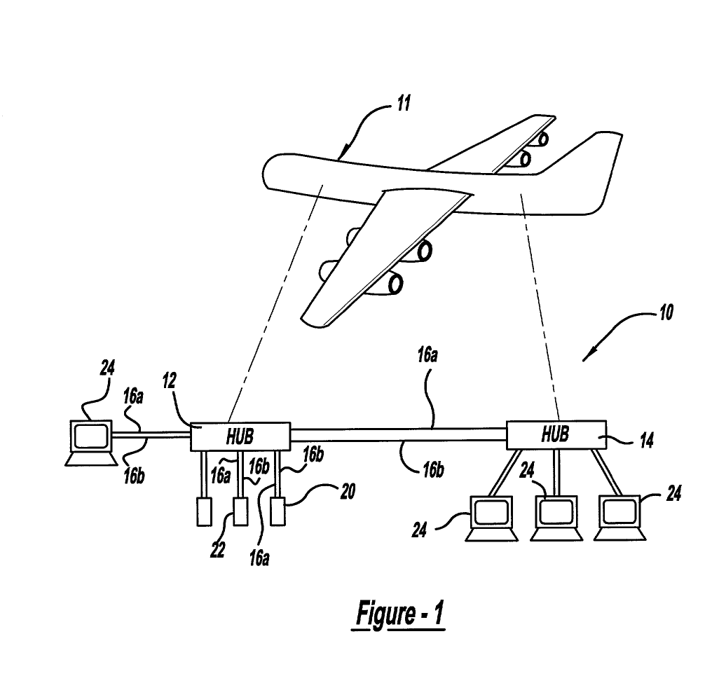

With reference to FIG. 1 of the drawings, a mobile computer network constructed in accordance with the teachings of the present invention is generally indicated by reference numeral 10. The computer network 10 is schematically illustrated to be coupled to an aircraft 11 which, other than as detailed herein, is conventional in its construction and operation. Those skilled in the art will understand, however, that the computer network 10 may be coupled to other types of mobile platforms, including ships, boats, barges, trains, buses, cars and trucks and as such, the particular embodiment illustrated is not intended in any way to limit the scope of the present invention.

The computer network 10 utilizes an Ethernet protocol, such as 100BASE-TX, and includes a first device 12, a second device 14 and a pair of cable assemblies 16a and 16b. In the example provided, the first device 12 is a switched hub and the second device 14 is another hub. In the particular example provided, a server 20 and a printer 22 are coupled to the first device 12 and a plurality of personal workstations 24 are coupled to the second device 14. Those skilled in the art will understand, however, that the devices 12, 14, 20, 22 and 24 may be any suitable devices for coupling an Ethernet computer network, including but not limited to devices, such as gateways, bridges, hubs, switches, routers, repeaters, nodes, printers, workstations, mass data storage devices, computers, terminals, plotters, photocopiers, telecopiers, image monitors, and servers.

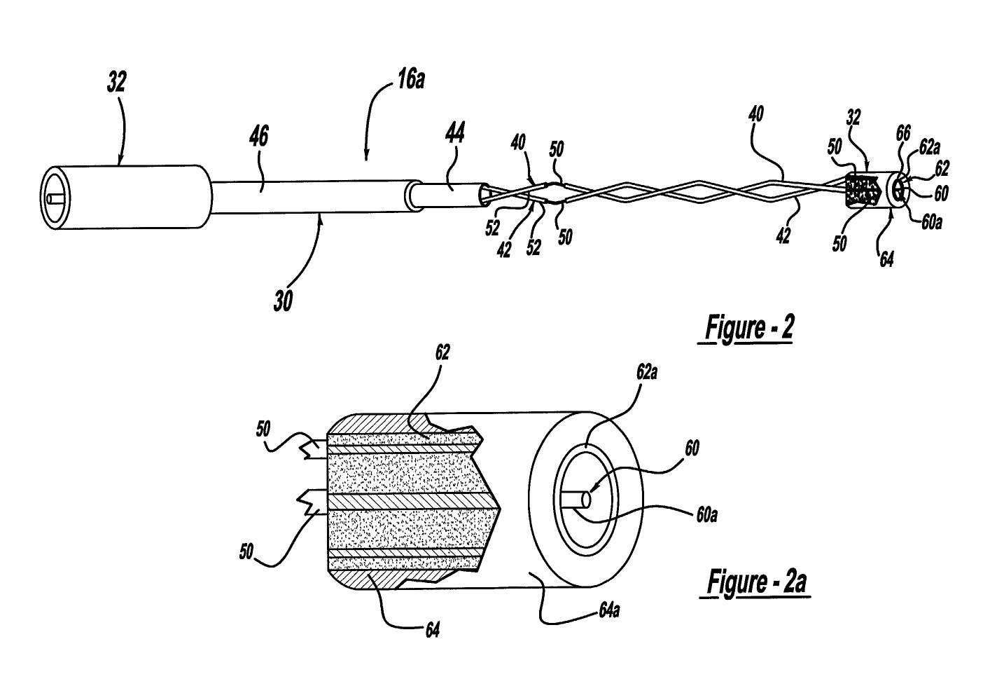

With additional reference to FIGS. 2 and 2a, the construction of the cable assembly 16a is shown in detail. As the cable assembly 16b are generally identical in construction, and a detailed description of one, such as the cable assembly 16a, will suffice for both. The cable assembly 16a is illustrated to include a cable 30 and a pair of contact assemblies 32. The cable 30 includes a first wire 40, a second wire 42, a shield conductor 44 and a protective sheath 46. Each of the first and second wires 40 and 42 includes a conducting element 50 and a sheath 52 that is formed from an electrically insulating material. The first and second wires 40 and 42 are twisted about one another over substantially their entire length. The shield conductor 44 is formed from a conductive film and encircles the first and second wires 40 and 42 and is electrically connected to each of the contact assemblies 32. The protective sheath 46 is formed from an electrically insulating material that encircles the shield conductor 44.

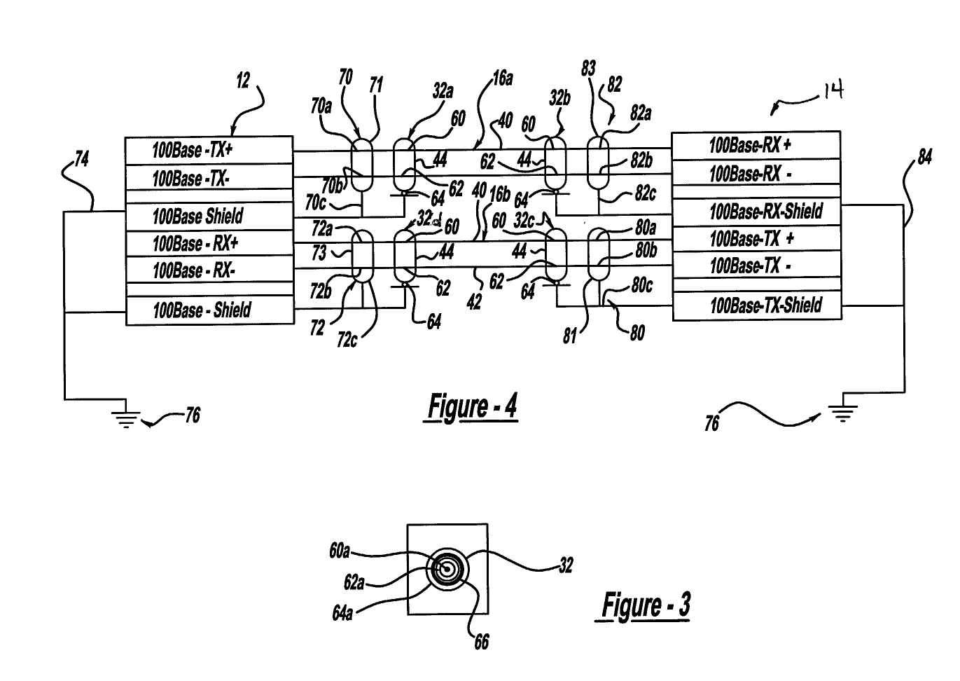

The contact assemblies 32 are commercially available from ITT Cannon under the tradename “BKA” (e.g., part number 349-1081-0000) and include three conductors that are arranged concentric to one another, with each of the conductors being separated by an insulating material along at least a portion of the length of the conductors. With additional reference to FIG. 3, the first conductor 60 is a pin 60a, the second conductor 62 is an annular ring 62a that surrounds the pin 60a, and the third conductor 64 is a sleeve 64a that surrounds the annular ring 62a. An electrically insulating ring 66 is preferably disposed between the annular ring 62a and the sleeve 64a. Each contact assembly 32 is coupled to an end of the cable 30 such that the first conductor 60 is electrically coupled to the first wire 40, the second conductor 62 is electrically coupled to the second wire 42 and the third conductor 64 is electrically coupled to the shield conductor 44. Any conventional means for electrically connecting the cable 30 and the conductor assemblies 32, such as soldering or crimping, may be used.

In FIG. 4, a portion of the computer network 10 is schematically illustrated. The first device 12 is illustrated to include a transmit port 70 and a receive port 72. The transmit port 70 is shown to include a mating contact assembly 71 having a positive transmit terminal 70a, a negative transmit terminal 70b, and a transmit shield 70c. The receive port 72 is shown to include a mating contact assembly 73 having a positive receive terminal 72a, a negative receive terminal 72b and a receive shield 72c. The transmit shield 70c and the receive shield 72c are coupled to a ground terminal 74 (e.g., the chassis) of the first device 12, which is preferably electrically coupled to the electrical ground 76 of the aircraft 11. Similarly, the second device 14 is illustrated to include a transmit port 80 and a receive port 82. The transmit port 80 is shown to include a mating contact assembly 81 having a positive transmit terminal 80a, a negative transmit terminal 80b and a transmit shield 80c. The receive port 82 is shown to include a mating contact assembly 83 having a positive receive terminal 82a, a negative receive terminal 82b and a receive shield 82c. The transmit shield 80c and the receive shield 82c are coupled to a ground terminal 84 (e.g., the chassis) of the second device 14, which is preferably electrically coupled to the electrical ground 76 of the aircraft 11.

Each of the cable assemblies 16a and 16b couples the transmit port of one device to the receive port of the other device. In the example illustrated, the cable assembly 16a couples the transmit port 70 of the first device 12 to the receive port 82 of the second device 14. In this regard, the contact assembly 32a is slidingly coupled to the mating contact assembly 71 such that the first conductor 60 matingly engages the positive transmit terminal 70a, the second conductor 62 matingly engages the negative transmit terminal 70b and the third conductor 64 mating engages the transmit shield 70c. Similarly, the contact assembly 32b is slidingly coupled to the mating contact assembly 83 such that the first conductor 60 matingly engages the positive receive terminal 82a, the second conductor 62 matingly engages the negative receive terminal 82b and the third conductor 64 mating engages the receive shield 82c. The cable assembly 16b is coupled to the receive port 72 and the transmit port 80 in a similar manner. In this regard, the contact assembly 32d is slidingly coupled to the mating contact assembly 73 such that the first conductor 60 matingly engages the positive receive terminal 72a, the second conductor 62 matingly engages the negative receive terminal 72b and the third conductor 64 mating engages the receive shield 72c. Similarly, the contact assembly 32c is slidingly coupled to the mating contact assembly 81 such that the first conductor 60 matingly engages the positive transmit terminal 80a, the second conductor 62 matingly engages the negative transmit terminal 80b and the third conductor 64 mating engages the transmit shield 80c. As those skilled in the art will appreciate, mating engagement of the contact assemblies with their associated mating contact assembly is accomplished by aligning the axis of the contact assembly 32 to the axis of the mating contact assembly and pushing the contact assembly 32 into engagement with the conductors of the mating contact assembly.

During the operation of the computer network 10, the cable assembly 16a facilitates the transmission of data from the first device 12 to the second device 14, and the cable assembly 16b facilitates the transmission of data from the second device 14. As the individual data signals are contained in separate shielded cable assemblies, emission of energy to or from adjacent wiring is substantially reduced.

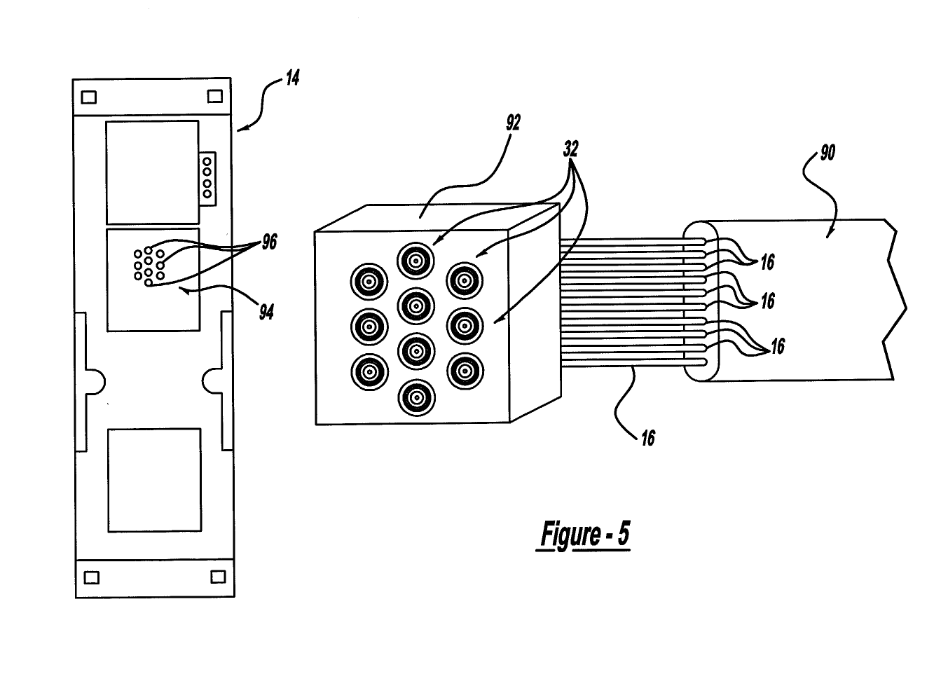

Also advantageously, several cable assemblies (e.g., cable assemblies 16a and 16b) may be integrated into a single cable assembly 90 as illustrated in FIG. 5. In the embodiment illustrated, each of the ten cable assemblies 16 is shown to be fixedly coupled to an AWG 8 connector assembly 92. The connector assembly 92 is configured to engage a mating connector assembly 94 to permit the contact assembly 32 of each of the cable assemblies 16 to be simultaneously electrically coupled to an associated mating contact assembly 96 in the mating connector assembly 94.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A computer network utilizing an Ethernet protocol, the computer network comprising:
a first device;
a second device;
a first cable assembly coupling the first and second devices to one another and facilitating data transmission from the first device to the second device; and
a second cable assembly coupling the first and second devices to one another and facilitating data transmission from the second device to the first device;
wherein each of the first and second cable assemblies consist essentially of a cable, a first contact assembly and a second contact assembly, the cable being formed with a pair of wires that are twisted about one another and shielded by a shield conductor, each of the first and second contact assemblies including a first conductor, a second conductor and a third conductor, the first conductor being electrically coupled to a first one of the pair of wires, the second conductor being electrically coupled to the other one of the pair of wires and the third conductor being electrically coupled to the shield conductor.

2. The computer network of claim 1, wherein the first conductor is an axially extending pin.

3. The computer network of claim 2, wherein the second conductor is an annular ring that surrounds the pin.

4. The computer network of claim 3, wherein the third conductor is a sleeve that surrounds the annular ring.

5. The computer network of claim 1, wherein the first and second devices communicate via an Ethernet 100 base-TX protocol.

6. The computer network of claim 1, wherein at least one of the first and second devices is an Ethernet hub.

7. The computer network of claim 6, wherein the Ethernet hub is selected from a group comprising of gateways, bridges, repeaters, switches and routers.

8. The computer network of claim 1, wherein at least one of the first and second devices is a node.

9. The computer network of claim 8, wherein the node is selected from a group comprising of terminals, mass storage devices, printers, plotters, photocopiers, telecopiers, image monitors, work stations and servers.

10. An aircraft having an onboard computer network, the computer network utilizing an Ethernet protocol and including a first device a second device, and a pair of cable assemblies for electrically coupling the first and second devices, each cable assembly including a cable and a pair of contact assemblies, the cable comprising a first wire, a second wire and a shield conductor, the first and second wires being twisted about one another over substantially their entire length, the shield conductor surrounding the first and second wires, each of the contact assemblies being coupled to an opposite end of the cable and including three electrical conductors that are arranged concentric to one another, each of the three electrical conductors being coupled to one of the first wire, the second wire and the shield conductor, wherein a first one of the cable assemblies facilitates data transmission from the first device to the second device and the other one of the cable assemblies facilitates data transmission from the second device to the first device.

11. The aircraft of claim 10, wherein a first one of the three electrical conductors is a pin that is coupled to the first wire.

12. The aircraft of claim 11, wherein a second one of the three electrical conductors is an annular ring that extends at least partially around the pin, the annular ring being coupled to the second wire.

13. The aircraft of claim 12, wherein a third one of the three electrical conductors is a sleeve that extends at least partially around the annular ring, the sleeve being coupled to the shield conductor.

14. The aircraft of claim 10, wherein at least one of the first and second devices includes a chassis to which the shield conductors of each of the cable assemblies are electrically coupled.

15. The aircraft of claim 14, wherein the chassis is electrically coupled to an electrical ground of the aircraft.

16. The aircraft of claim 10, wherein the first and second devices communicate via an Ethernet 100 base-TX protocol.

17. The computer network of claim 10, wherein at least one of the first and second devices is an Ethernet hub.

18. The computer network of claim 17, wherein wherein the Ethernet hub is selected from a group comprising of gateways, bridges, repeaters, switches and routers.

19. The computer network of claim 10, wherein at least one of the first and second devices is a node.

20. The computer network of claim 19, wherein the node is selected from a group comprising of terminals, mass storage devices, printers, plotters, photocopiers, telecopiers, image monitors, work stations and servers.
